(19) United States
(12) Patent Application Publication
(10) Pub. No.: US 2006/0150176 A1
(43) Pub. Date: Jul. 6, 2006

(54) Maintaining software and data

(76) Inventors: Brian Thomas Dorricott, Clevedon (GB); Simon Paul Tyler, Malmesbury (GB)

Correspondence Address: REISING, ETHINGTON, BARNES, KISSELLE, P.C., P O BOX 4390, TROY, MI, 48099-4390, US

(21) Appl. No.: 11/287,688

(22) Filed: Nov. 28, 2005

Related U.S. Application Data
(63) Continuation-in-part of application No. 09/824,453, filed on Apr. 2, 2001, now abandoned.

(30) Foreign Application Priority Data
Nov. 27, 2000 (GB) 0028880.3

(51) Int. Cl. G06F 9/44

(52) U.S. Cl. 717/168; 717/171

(57) ABSTRACT

A method of updating software and/or data in any one of a plurality of recipient computers, the update being provided to the recipient computer by a data owner computer. The recipient computer sends an update request as an e-mail message to the data owner computer. The update request specifies files to be updated and includes a message ID unique to the update request. The data owner computer automatically analyzes the update request to determine files to be updated and prepares a corresponding update in response to receiving the update request e-mail. The owner computer automatically sends the update to the recipient computer. The update comprises an email message having one or more files to be updated included as attachment files in the e-mail message; and including the unique message ID. The recipient computer automatically responds to the update by opening the attachment files and updating the software and/or data.

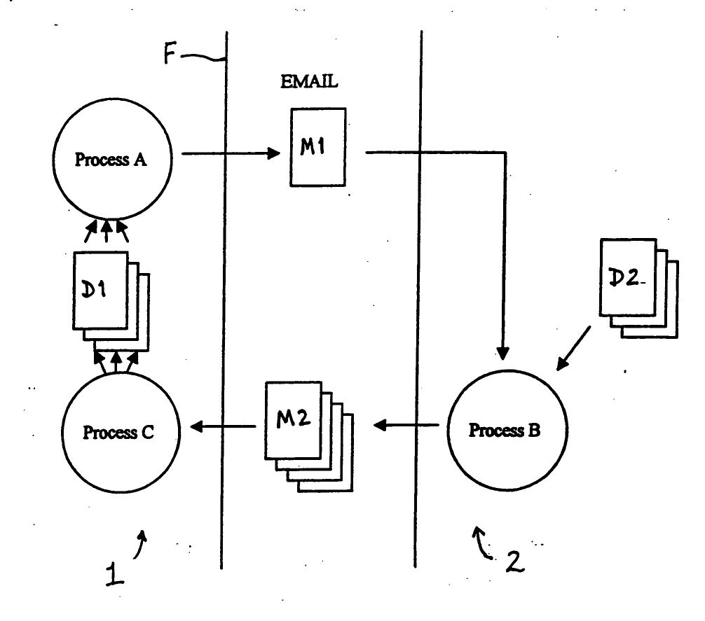

### CROSS-REFERENCES TO RELATED APPLICATIONS

This application is a continuation-in-part of Ser. No. 09/824,453, filed on Apr. 2, 2001, which is based on GB Application No. 0028880.3, filed Nov. 27, 2000.

### STATEMENT REGARDING FEDERALLY SPONSORED RESEARCH OR DEVELOPMENT

Not Applicable

### BACKGROUND OF THE INVENTION

1. Field of the Invention

This invention relates to a method of updating computer software and/or data.

2. Description of the Related Art Including Information Disclosed Under 37 CFR 1.97 and 1.98

Maintaining computer software and data requires two parties: the recipient and the owner. Currently there are two main solutions available to parties to install new software/data on the recipient's system. Either a human obtains the software/data and logs on to the console of the computer and follows the upgrade procedure; or upgrade software automatically contacts a recipient system and sends an update which is installed automatically without any additional human intervention.

Both of these solutions have problems. A human introduces delays due to scheduling which could cause vital updates to be applied late causing consequential losses (e.g. security breaches, continued incorrect operation, etc.). Automatic updating requires the two computers to be in direct communication with each other, which may not be possible due to a variety of restrictions including the presence of fire-walls, IP address translation, military secrecy requirements, etc. Furthermore, each time an update takes place, the whole data set may have to be transferred.

### BRIEF SUMMARY OF THE INVENTION

According to the invention there is provided a method of updating computer software and/or data in any one of a plurality of recipient computers, a recipient computer being a computer that is to be updated, the update being provided to the recipient computer by a data owner computer, the method comprising the steps of said recipient computer sending an update request as an e-mail message to the data owner computer, the update request specifying the files to be updated; and including a unique message ID that is unique to the update request; said data owner computer automatically analysing the update request to determine the files to be updated and preparing a corresponding software and/or data update in response to receiving the update request e-mail; said owner computer automatically sending said software and/or data update to said recipient computer, wherein the software and/or data update comprises an email message having one or more files to be updated included as attachment files in the e-mail message; and including the unique message ID; said recipient computer automatically responding to said software and/or data update by opening the attachment files and updating said software and/or data.

Because the recipient and owner computers communicate by e-mail, for example, using the well known, standard Internet electronic mail as the messaging medium, the security of the recipient computer can be maintained using a firewall system.

In addition, the recipient computer can send update requests and respond to update responses in a manner that suits its own operating schedules. The owner computer can also implement its own policies in responding to update requests, for example, based on version control or the payment of licence fees or support fees.

Preferably, the update requests and responses are compiled by reference to a data directory available to both the recipient and owner computers so that only files identified by the recipient computer in the update request need to be updated in the update response. These files are preferably sent as attachments in the e-mailed update response.

It will be appreciated that the whole process of updating the recipient computer by sending an update request and responding to the corresponding update response can be automated so that human intervention is not required.

Examples of problems solved using the invention include: the updating of virus signature files on systems behind company firewalls without the virus signature file vendor knowing the location of the recipient system; automatic updating of application servers with new applications in a distributed thin-client environment without having to allow access through firewalls; maintaining remote back-ups of many computer systems from a central location, the recipient system being the system that is to be backed up, and an administrator at a central location maintaining the backups at their own schedule through firewalls; software vendors providing customers with updates to software as each version is released.

### BRIEF DESCRIPTION OF THE DRAWING

The invention will now be described by way of example with reference to the accompanying schematic drawing showing a recipient computer 1 and owner computer 2 communicating according to the invention to update the recipient computer.

### DETAILED DESCRIPTION OF EMBODIMENTS OF THE INVENTION

Computer 1 is any machine that is connected to the Internet (either full time or dial-up) running an Internet Mail server. In this description, we will consider only computer 1, although there will be any number of these machines. Computer 1 has a “Data directory” which contains a set of files D1 that should be kept synchronised with the “Data Owner's” set of files D2. These files may contain any form of information, data or program executable.

At a specific time (defined by the owner of Computer 1), the computer 1 examines its data directory and composes an e-mail message with a list identifying each file it would like updated. In addition to the e-mail message itself, computer 1 also generates a unique message ID, which is unique to the e-mail message. The unique message ID (UID) is generated by performing a hash function on one or more data items, at least one of which is taken from the e-mail message itself. In a preferred embodiment the UID is generated by hashing a data item from the e-mail message (suitable data items include the sender's email address or other predefined filed, such as the ‘type’ of update being requested i.e. Anti-Virus or Anti-Spam. However, other data items from the email message are equally usable), a previously determined password known to both computer 1 and computer 2, the current time and a randomly generated number. Once the UID is generated a further has function is performed on the e-mail message itself, the previously determined password, the current time and the UID. This hash sum, together with the UID, is attached to the e-mail message to form a final message (M1), also termed the update request. The process of generating the original e-mail message, the UID, hash sum and update request (M1) is illustrated in the FIGURE as process A. The message M1 is “from” the account on computer 1 which has the power to process the response when it arrives.

The message M1 is forwarded to a known account on the data's owners e-mail server 2. The message may pass through many other Internet Mail servers and/or gateways before it reaches it destination. This allows computer 1 to request updates even though it has no direct connection to the data owner (e.g. it is behind a company firewall F, in a secure site, etc.).

When the Internet Mail Server 2 of the data owner receives the update request message M1, it accepts the e-mail message and compares each file specification D1 with its up-to-date version D2 (Process B). As it works through the file list, it creates a new e-mail message (M2) which has a list of all the files that have changed followed by the files themselves. Also attached to the new e-mail message (M2) is the UID that was sent with the update request (M1), together with a further hash sum generated by performing a hash function on at least the new e-mail message (M2) itself and the UID. This message (M2) is a standard Internet E-mail Message with attachments. This means that the message will pass through any Internet Mail server and multiple gateways via other messaging systems (e.g. X-400, MSMail, etc.). When Process B is complete, the resulting e-mail message M2 is posted (using standard Internet Mail) to computer 1.

When the standard e-mail message M2 is received at computer 1, Process C is triggered which accepts the e-mail message and examines the contents. Computer 1 then proceeds to unpack each file D2 and over-writes the corresponding files D1.

By attaching the UID to the e-mail message (M2) from the owner computer it allows the recipient computer to always pair-up a received e-mail message containing updates with the corresponding update request (M), even if one or more other e-mail messages have been received from the owner computer in the intervening period. For example, supposing that Computer 1 sends 4 update requests R1, R2, R3 & R4 and subsequently receives the updates in the order U2, U3, U1 & U4 then Computer 1 can be arranged to apply U2, apply U3, ignore U1 and apply U4 or alternatively save U2, save U3, apply U1, then retrieve and apply U2 & U3 and then apply U4. Additionally, it allows the recipient computer to identify an e-mail message from the owner computer that has no corresponding update request. This enhances the security of the updating process since it removes the possibility of a malicious third party sending an unsolicited e-mail message containing corrupted update files, since the recipient computer is able to detect either the lack of UID, or detect that the attached UID does not match a UID generated by the recipient computer, and is able to reject the malicious update e-mail. Since the generation of the UID uses both a randomly generated number and a timestamp, the UID is absolutely unique to each update request, even if the request specifies exactly the same data files to be updated as a previous request.

Obviously, it's possible to modify this invention from what the description teaches. Within the scope of the claims one may practice the invention other than as described.

1. A method of updating computer software and/or data in any one of a plurality of recipient computers, a recipient computer being a computer that is to be updated, the update being provided to the recipient computer by a data owner computer, the method comprising the steps of:
said recipient computer sending an update request as an e-mail message to the data owner computer, the update request specifying the files to be updated and including a unique message ID that is unique to the update request;
said data owner computer automatically analysing the update request to determine the files to be updated and preparing a corresponding software and/or data update in response to receiving the update request e-mail;
said owner computer automatically sending said software and/or data update to said recipient computer, wherein the software and/or data update comprises an email message having one or more files to be updated included as attachment files in the e-mail message and including the unique message ID;
said recipient computer automatically responding to said software and/or data update by opening the attachment files and updating said software and/or data.

2. A method as claimed in claim 1, in which the recipient computer generates the message ID by performing a first hash function on at least a portion of the update request, a password, a time stamp and a randomly generated number.

3. A method as claimed in claim 1, in which the recipient computer performs a second hash function on the update request, a password, a timestamp and the unique message ID, the resulting hash sum being subsequently sent to the owner computer with the update request.

4. A method as claimed in claim 1, in which on receipt of the software and/or data update at the recipient computer the recipient computer searches for a previously sent update request having a unique message ID matching the unique message ID included in the software and/or data update and if no such update request is found the recipient computer inhibits the processing of the software and/or data update.

5. A method as claimed in claim 1 in which the update request is compiled at the recipient computer by reference to a data directory, and the software and/or data update is compiled at the data owner computer by reference to the same data directory, only the files identified in the update request being updated in the software and/or data update.

6. A method as claimed in claim 1 in which the software and/or data update is protected by a password.

7. A method as claimed in claim 1 in which the e-mail update request is transmitted via the internet.

8. A method as claimed in claim 1 in which the recipient computer is protected by a fire-wall through which it communicates in sending said e-mail update request.

9. A method as claimed in claim 1 in which the computer software and/or data to be updated is selected from the group consisting of a virus signature, a software application, and data to be backed-up by the data owner computer.
